(19) United States
(12) Patent Application Publication
(10) Pub. No.: US 2011/0272621 A1
(43) Pub. Date: Nov. 10, 2011

(54) PROCESS FOR MANUFACTURING INSULATION PRODUCTS BASED ON MINERAL WOOL, AND PRODUCTS OBTAINED

(75) Inventors: Boris Jaffrennou, Paris (FR); Jerome Douce, Paris (FR); Helene Menival, Margny-les-compiegne (FR); Olivier Pons Y Moll, Agnetz (FR)

(73) Assignee: SAINT-GOBAIN ISOVER, Courbevoie (FR)

(21) Appl. No.: 13/123,419

(22) PCT Filed: Oct. 8, 2009
(86) PCT No.: PCT/FR09/51923

§ 371 Date: Jun. 27, 2011

(30) Foreign Application Priority Data
Oct. 8, 2008 (FR) 0856812

(51) Int. Cl. E04B 1/88; B05C 21/00; B05D 1/02

(52) U.S. Cl. 252/62; 427/209; 118/65

(57) ABSTRACT

The present invention relates to a process for manufacturing thermal and/or acoustic insulation products based on mineral wool, especially on rock wool or glass wool, bound by a sizing composition based on a thermosetting resin, in particular of resol type, which aims to limit the emissions of formaldehyde.

The method is characterized in that it comprises a step that consists in applying a composition of an agent capable of reacting with formaldehyde, chosen from compounds having active methylene(s), to the insulation product, after the thermosetting resin has crosslinked.

Another subject of the present invention is the device for carrying out the aforementioned process and the insulating products based on mineral fibers that are obtained.

The invention relates to a process for manufacturing thermal and/or acoustic insulation products based on mineral wool, bound by a sizing composition based on a thermosetting resin, in particular of resol type, which aims to limit the emissions of formaldehyde. The process is characterized in that it comprises a step that consists in applying an agent capable of reacting with formaldehyde, chosen from compounds having active methylene(s), to the insulation product, after the thermosetting resin has crosslinked.

The invention also relates to the insulating products based on mineral fibers obtained by said manufacturing process.

The insulation products based on mineral wool may be formed from fibers obtained by various processes, for example according to the known technique of fiberizing by internal or external centrifugation.

Internal centrifugation consists in introducing the molten (in general glass or rock) material into a spinner that has a multitude of small holes, the material being projected against the peripheral wall of the spinner under the action of the centrifugal force and being expelled therefrom in the form of filaments. On leaving the spinner, the filaments are attenuated and entrained by a high-velocity, high-temperature gas stream to a receiving member in order to form a layer of fibers.

As regards external centrifugation, it consists in pouring out the molten material onto the external peripheral surface of rotating members known as rotors, from where said material is ejected under the action of the centrifugal force. Means for attenuating via gas stream and for collecting on a receiving member are also provided.

To assemble the fibers together and provide the layer with cohesion, the fibers, on leaving the spinner, are sprayed with a sizing composition containing a thermosetting resin. The layer of fibers coated with the size is subjected to a heat treatment (at a temperature generally above 100° C.) in order to carry out the polycondensation of the resin and thus obtain a thermal and/or acoustic insulation product having specific properties, especially dimensional stability, tensile strength, thickness recovery after compression and uniform color.

The sizing composition is most often sprayed onto the fibers. Generally, the sizing composition contains the resin (which is usually in the form of an aqueous solution), additives such as urea, one or more silanes, a mineral oil, aqueous ammonia and a polycondensation catalyst, and water.

The thermosetting resins most commonly used are phenolic resins belonging to the family of resols. These resins are very soluble in water, have a good affinity for the mineral, especially glass, fibers, make it possible to obtain the elasticity and thickness recovery properties already mentioned for the insulation products, and are relatively inexpensive.

Resols are obtained by condensation of a phenolic compound and of an aldehyde, in the presence of a basic catalyst in an aldehyde/phenolic compound molar ratio greater than 1 and under reaction conditions that make it possible to have a minimal amount of free phenolic compound. These resols generally contain free aldehyde in an amount which depends on the aldehyde/phenolic compound molar ratio used.

The resols most commonly used are condensates of phenol and of formaldehyde. One drawback of these resols is linked, in particular, to the presence of free formaldehyde which is capable of being emitted into the atmosphere during the manufacture of the insulation product on the production line and/or by the insulation product over time.

To overcome this drawback, it is known to add, to the resol, a sufficient amount of urea which reacts with the free formaldehyde forming urea-formaldehyde condensates (see EP 0 148 050 A1). The resin obtained contains phenol-formaldehyde condensates and urea-formaldehyde condensates, has an amount of free formaldehyde and of free phenol, expressed by total weight of liquid, of less than or equal to 3% and 0.5% respectively.

However, it has been observed that this resin is not stable under the temperature conditions to which the sized fibers are subjected in order to obtain the crosslinking of the resol: the urea-formaldehyde condensates are degraded and release formaldehyde and ammonia, which increases the amount of undesirable gases to be treated before they are released into the atmosphere.

It has also been observed that formaldehyde may be released from the final product during its use as thermal and/or acoustic insulation under the effect of thermal and hygrometic variations linked to climatic cycles.

For several years, the regulations with regard to undesirable emissions have been becoming increasingly severe and tend to limit, in particular, the amount of formaldehyde which may be emitted by a thermal and/or acoustic insulation product.

Alternatives have been proposed in order to replace the resols with resins that do not involve formaldehyde, for example epoxy resins and polyester resins, especially obtained by reaction of polyvinyl alcohol and of a polyacid, or of an acrylic polyacid and of a polyol. However, these resins are very expensive. Excluding epoxy resins, these resins also require, for their implementation, specific installations which can withstand acid corrosion (the pH of these resins is generally below 4, or even 3), which leads to a significant supplementary cost.

The objective of the present invention is to propose a process for manufacturing a thermal and/or acoustic insulation product, based on mineral wool sized with a thermosetting resin, in particular of resol type, which makes it possible to limit the amount of formaldehyde which may be emitted by said insulation product.

Another objective of the invention is to provide a process which does not substantially affect the quality of the products, especially the thermal and/or acoustic insulation properties and the mechanical properties.

Another objective of the invention is to propose a process which meets the requirements of an industrial manufacture, which is easy to implement and which does not require significant modifications of the customary production line.

In order to achieve these objectives, the invention proposes to add, to the process for manufacturing mineral wool, a step that consists in applying a composition of an agent capable of reacting with formaldehyde, chosen from compounds having active methylene(s), to the insulating product, after the thermosetting resin has crosslinked.

As already indicated, the manufacture of thermal and/or acoustic insulation products based on mineral wool is known (see in particular EP-A-0 189 354 and EP-A-0 519 797).

Conventionally, a line for producing glass wool by internal centrifugation comprises a series of spinners. The fibers that are expelled therefrom under the effect of the centrifugal force are treated with a sizing composition and then collected on receiving members of the suction belt type, the fibers coming from each spinner being deposited as successive layers on the belt which then conveys them through an oven equipped with shaping rolls. The heat treatment undergone during passage through the oven makes it possible to dry, crosslink and cure the sizing composition. On exiting the oven, the insulation product composed of fibers bound by the crosslinked size is dried and generally cut to the desired dimensions before being packaged, for example in the form of one or more panels or rolls.

The process according to the present invention comprises a step that consists in applying a composition of an agent capable of reacting with formaldehyde chosen from compounds having active methylene(s), to the insulation product, after the crosslinking of the resol contained in the sizing composition.

The treatment of the insulation product with the composition containing said agent is carried out downstream of the heat-treatment device, of oven type, which aims to crosslink the sizing composition

According to one preferred embodiment of the invention, which is particularly advantageous from an industrial standpoint, the composition of the agent capable of reacting with formaldehyde is applied continuously on the production line.

Although it is preferred to apply the composition of the agent capable of reacting with formaldehyde at the very latest to the cut product, before packaging, it cannot be ruled out that said composition could be applied off-line to the finished product, even if this requires an additional step of drying in the open air or with suitable heating means in order to remove the water and the cosolvent(s) from the composition as explained later on.

Advantageously, the composition containing the agent capable of reacting with formaldehyde is applied just at the outlet of the oven whilst the insulation product is still hot, that is to say at a temperature of around 50 to 80° C., preferably 60 to 70° C. This method of proceeding is doubly advantageously: it makes it possible to treat the insulation product solely at the surface while enabling the agent capable of reacting with formaldehyde to penetrate into the product to a thickness which may vary from a few mm to a few cm depending on the density of the product; and it allows efficient drying by rapid removal of the water and cosolvent(s) by taking advantage of the heat contained in the insulation product on exiting the oven.

The composition of the agent capable of reacting with formaldehyde may be applied by any known means suitable for the application of liquids, especially by spraying and by curtain coating or roll coating.

It may be applied to the upper face of the insulation product exiting the oven, and where appropriate to the lower face, advantageously by spraying onto the upper face and by roll coating onto the lower face.

The sizing composition that can be used in the context of the invention comprises a resin capable of crosslinking under the effect of heat, in particular a resol of the phenol-formaldehyde type, preferably a resol as described in WO-A-99/03906 and WO-A-01/96254, or a resol of phenol-formaldehyde-amine type, as described in WO-A-2008/043960 and WO-A-2008/043961.

The sizing composition may comprise urea in an amount which may range up to 50 parts of urea per 100 parts by dry weight of the mixture composed of the resin and the urea.

Generally, the sizing composition also comprises the additives below in the following weight proportions, expressed in parts per 100 parts by dry weight of resin and where appropriate of urea:
0 to 10 parts of a polycondensation catalyst, for example ammonium sulfate, preferably less than 7 parts,
0 to 2 parts of silane, in particular an aminosilane;
0 to 20 parts of oil, preferably 6 to 15 parts; and
0 to 20 parts of aqueous ammonia (20 wt % solution), preferably less than 12 parts.

The role of the additives is known and is briefly summarized: the urea makes it possible to adjust the gel time of the sizing composition in order to avoid possible problems of pre-gelling; the ammonium sulfate serves as a catalyst for the polycondensation (in the oven at high temperature) after spraying the sizing composition onto the fibers; the silane is a coupling agent between the fibers and the resin, and also acts as an anti-ageing agent; the oils are anti-dust and hydrophobic agents; the aqueous ammonia acts, at low temperature, as a polycondensation retarder.

The sizing composition is deposited on the mineral fibers in an amount of 2 to 15% by dry weight of the total weight of the fibers, preferably of 4 to 10%, especially of around 5%.

The temperature for crosslinking the sizing composition in the heat-treatment device of the oven type is generally between 75 and 300° C., preferably 100 and 250° C.

The agent capable of reacting with formaldehyde is chosen from compounds having active methylene(s), preferably that correspond to the following formulae:

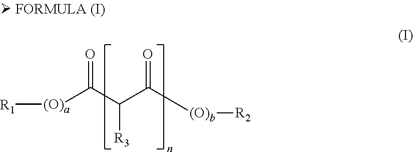

in which:
R₁ and R₂, which are identical or different, represent a hydrogen atom, a C₁-C₂₀, preferably C₁-C₆, alkyl radical, an amino radical or a radical of formula

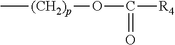

in which R₄ represents a

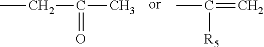

radical, where R₅═H or —CH₃ and p is an integer that varies from 1 to 6;
R₃ represents a hydrogen atom, a C₁-C₁₀ alkyl radical, a phenyl radical or a halogen atom;
a is equal to 0 or 1;
b is equal to 0 or 1; and
n is equal to 1 or 2.

The preferred compounds of formula (I) are:

2,4-pentanedione:
R₁=—CH₃; R₂=—CH₃; R₃=H; a=0; b=0; n=1

2,4-hexanedione:
R₁=—CH₂—CH₃; R₂=—CH₃; R₃=H; a=0; b=0; n=1

3,5-heptanedione
R₁=—CH₂—CH₃; R₂=—CH₂—CH₃; R₃=H; a=0; b=0; n=1

2,4-octanedione:
R₁=—CH₃; R₂=—(CH₂)₃—CH₃; R₃=H; a=0; b=0; n=1

acetoacetamide:
R₁=—CH₃; R₂=—NH₂; R₃=H; a=0; b=0; n=1

N-monomethylacetoacetamide:
R₁=—CH₃; R₂=—NH(CH₃); R₃=H; a=0; b=0; n=1

N-monoethylacetoacetamide:
R₁=—CH₃; R₂=—NH(CH₂—CH₃); R₃=H; a=0; b=0; n=1

N,N-dimethylacetoacetamide:
R₁=—CH₃; R₂=—N(CH₃)₂; R₃=H; a=0; b=0; n=1

N,N-diethylacetoacetamide:
R₁=—CH₃; R₂=—N(CH₂—CH₃)₂; R₃=H; a=0; b=0; n=1

acetoacetic acid:
R₁=—CH₃; R₂=H; R₃=H; a=0; b=1; n=1

methyl acetoacetate:
R₁=—CH₃; R₂=—CH₃; R₃=H; a=0; b=1; n=1

ethyl acetoacetate:
R₁=—CH₃; R₂=—CH₂—CH₃; R₃=H; a=0; b=1; n=1

n-propyl acetoacetate:
R₁=—CH₃; R₂=—(CH₂)₂—CH₃; R₃=H; a=0; b=1; n=1

isopropyl acetoacetate:
R₁=—CH₃; R₂=—CH(CH₃)₂; R₃=H; a=0; b=1; n=1

isobutyl acetoacetate:
R₁=—CH₃; R₂=—CH₂—CH(CH₃)₂; R₃=H; a=0; b=1; n=1

t-butyl acetoacetate:
R₁=—CH₃; R₂=—C(CH₃)₃; R₃=H; a=0; b=1; n=1

n-hexyl acetoacetate:
R₁=—CH₃; R₂=—(CH₂)₅—CH₃; R₃=H; a=0; b=1; n=1

malonamide:
R₁=—NH₂; R₂=—NH₂; R₃=H; a=0; b=0; n=1

malonic acid:
R₁=H; R₂=H; R₃=H; a=1; b=1; n=1

dimethyl malonate:
R₁=—CH₃; R₂=—CH₃; R₃=H; a=1; b=1; n=1

diethyl malonate:
R₁=—CH₂—CH₃, R₂=—CH₂—CH₃; R₃=H; a=1; b=1; n=1

di-n-propyl malonate:
R₁=—(CH₂)₂—CH₃; R₂=—(CH₂)₂—CH₃; R₃=H; a=1; b=1; n=1

diisopropyl malonate:
R₁=—CH(CH₃)₂; R₂=—CH(CF₁₃)₂; R₃=H; a=1; b=1; n=1

di-n-butyl malonate:
R₁=—(CH₂)₃—CH₃; R₂=—(CH₂)₃—CH₃; R₃=H; a=1; b=1; n=1

acetonedicarboxylic acid:
R₁=H; R₂=H; R₃=H; a=1; b=1; n=2

dimethylacetone dicarboxylate:
R₁=—CH₃; R₂=—CH₃; R₃=H; a=1; b=1; n=2

1,4-butanediol diacetate
R₁=—CH₃; R₂=—(CH₂)₄—O—CO—CH₂—CO—CH₃; R₃=H; a=0; b=1; n=1

1,6-hexanediol diacetate
R₁=—CH₃; R₂=—(CH₂)₆—O—CO—CH₂—CO—CH₃; R₃=H; a=0; b=1; n=1

methacryloxyethyl acetoacetate
R₁=—CH₃; R₂=—(CH₂)₂—O—CO—C(CH₃)═CH₂; R₃=H; a=0; b=1; n=1

FORMULA (II)

R₆—CHR₇—C≡N (II)

in which:
R₆ represents a cyano radical or a

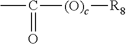

radical
in which:
   R₈ represents a hydrogen atom, a C₁-C₂₀, preferably C₁-C₆, alkyl radical, or an amino radical;
   c is equal to 0 or 1; and
R₇ represents a hydrogen atom, a C₁-C₁₀ alkyl radical, a phenyl radical or a halogen atom.

The preferred compounds of formula (II) are:

2-methyl cyanoacetate:
R₆=—CO—O—CH₃; R₇=H

2-ethyl cyanoacetate:
R₆=—CO—O—CH₂—CH₃; R₇=H

2-n-propyl cyanoacetate:
R₆=—CO—O—(CH₂)₂—CH₃; R₇=H

2-isopropyl cyanoacetate:
R₆=—CO—O—CH(CH₃)₂; R₇=H

2-n-butyl cyanoacetate:
R₆=—CO—O—(CH₂)₃CH₃; R₇=H

2-isobutyl cyanoacetate:
R₆=—CO—O—CH₂—CH(CH₃)₂; R₇=H

2-tert-butyl cyanoacetate:
R₆=—CO—O—C(CH₃)₃; R₇=H

2-cyanoacetamide:
R₆=—CO—NH₂; R₅=H

propanedinitrile:
R₆=—C≡N; R₅=H

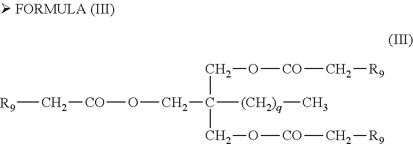

in which:
R₉ represents a

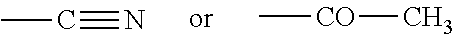

radical; and
q is an integer that varies from 1 to 4.

The preferred compounds of formula (III) are:

trimethylolpropane triacetoacetate:
R₉=—CO—CH₃; q=1

trimethylolpropane tricyanoacetate:
R₉=—C≡N; q=1

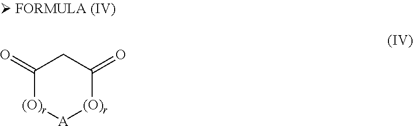

in which
A represents a —(CH₂)₃— or —C(CH₃)₂— radical; and
r is equal to 0 or 1.

The preferred compounds of formula (IV) are:

1,3-cyclohexanedione:
A=—(CH₂)₃; r=0

Meldrum's acid:
A=—C(CH₃)₂—; r=1

The composition of the agent capable of reacting with formaldehyde that can be used in the context of the invention comprises at least one compound having active methylene(s) that corresponds to any one of the aforementioned formulae (I) to (IV).

As already mentioned, the composition of said agent is applied in liquid form to the insulation product after the crosslinking of the sizing composition.

According to one preferred embodiment, the composition of the agent capable of reacting with formaldehyde is in the form of a solution, a dispersion or an emulsion in a liquid phase predominantly composed (containing more than 50% by weight) of water and of one or more organic cosolvents of said agent, these cosolvents preferably having a toxicity and an inflammability that are low and advantageously that are zero. Preferably, the liquid phase contains 75 to 90% by weight of water.

The content of agent capable of reacting with formaldehyde represents 0.1 to 90% by weight of the composition, preferably 0.5 to 50%, and better still 1 to 20%.

According to another embodiment that can be applied when the agent capable of reacting with formaldehyde is liquid, said agent is applied directly to the insulation product, without addition of water and of optional cosolvent(s). The term “liquid” is understood here to mean that said agent has a viscosity of less than 0.3 Pa·s at 25° C. Said agent can thus be used as is at ambient temperature, or even after having been heated moderately so that it becomes liquid and can be applied under the aforementioned conditions. The heating temperature must be below the degradation temperature of said agent.

The agent capable of reacting with formaldehyde is deposited on the insulating product in a sufficient amount to allow the reaction with the free formaldehyde present in the sizing composition and with the formaldehyde capable of being emitted subsequently under the usage conditions, essentially under the action of climatic cycles.

As a general rule, the composition of the agent capable of reacting with formaldehyde is applied under conditions such that the amount (by dry weight) of said agent varies from 0.01 to 50 g/m² of final insulation product, preferably from 0.1 to 10 g/m² and better still from 0.2 to 5 g/m².

The process according to the invention applies to any insulation product containing mineral fibers bound together by a crosslinked resin, which product may have a variable thickness and a variable density. This product may especially be a layer, a mat or a felt and may be provided on one of its faces with a facing, for example of kraft paper type.

The mineral fibers may be composed of glass or of rock, and have a length and a diameter which vary as a function of the usage of the insulation product.

Another subject of the invention is the device for carrying out the process described above.

The device comprises a line for producing mineral wool, especially by internal centrifugation, comprising a plurality of fiberizing members in series, at least one member for receiving/conveying the fibers resulting from the fiberizing members, one or more members for applying a sizing composition and one or more heat-treatment members of the oven type, this device being characterized in that it also comprises at least one spray boom for spraying a composition of an agent capable of reacting with formaldehyde onto the upper face of the insulation product downstream of the heat-treatment member(s).

With a view to treating the insulating product with the composition of the agent capable of reacting with formaldehyde, the device comprises one or more spray booms placed above the upper face of the insulation product. Preferably, the boom(s) comprise(s) a feed pipe provided with spray nozzles uniformly distributed over the length of the boom(s). These nozzles are capable of providing jets of liquid that are divergent and of varied shape that a person skilled in the art knows how to choose as a function of the desired use, and that are preferably “flat” (not conical). The relative configuration of the boom and of the product to be treated is adjusted so that the application of the composition of the agent capable of reacting with formaldehyde is uniform on the surface of the product, which may be obtained by ensuring that the jets of liquid meet above or on the product.

Advantageously, the spray boom(s) is (are) positioned near to the heat-treatment device of the oven type. Preferably, the first boom is facing a device that ensures the drying of said product, advantageously a suction device located below the lower face of the insulation product.

Where appropriate, the device may also comprise one or more coating rolls that allow the application of the composition of the agent capable of reacting with formaldehyde to the lower face of the insulation product, preferably located downstream of the heat-treatment member(s) and of the device ensuring the drying of said product.

Another subject of the invention is the thermal and/or acoustic insulation product obtained by the process according to the invention.

The insulation product thus comprises, at the surface, an agent capable of reacting with formaldehyde chosen from the compounds of the aforementioned formulae (I) to (IV).

As has already been stated, the amount (by dry weight) of agent capable of reacting with formaldehyde present in the final insulation product varies from 0.01 to 50 g/m² of final insulation product, preferably from 0.1 to 10 g/m² and better still from 0.2 to 5 g/m². This amount is sufficient to allow the reaction with the formaldehyde capable of being emitted under the conditions of use of the insulation product, essentially under the action of climatic cycles.

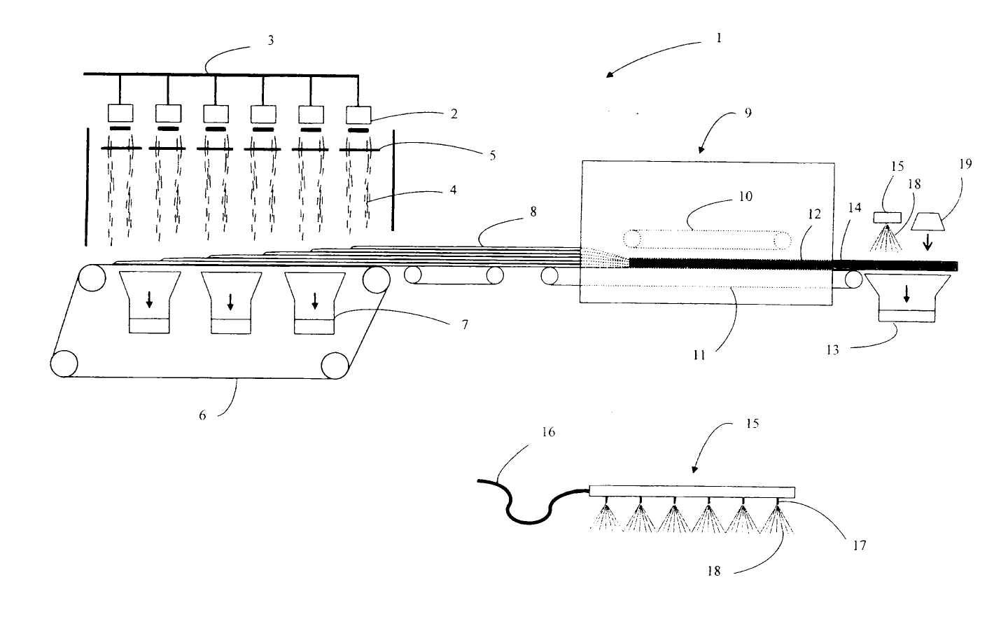

The invention is described in greater detail in FIG. 1 which represents a schematic view of a line for producing glass wool by internal centrifugation.

In FIG. 1, the line 1 comprises a plurality of internal centrifuging devices (spinners) 2 in series supplied with molten glass by the pipe 3 corning from a furnace for melting the glass raw materials (not represented). Glass fibers 4 distributed in the form of a torus are ejected from the spinners 2 and treated with a sizing composition dispensed by spray rings 5. The sized fibers are deposited by gravity on a transport device 6, for example a conveyor belt, equipped with suction devices 7 that are used to hold the fibers, in order to form a continuous strip 8 which is conveyed to an oven 9 equipped with devices 10, 11 for shaping the strip 8.

In the oven 9, the sizing composition crosslinks and binds the fibers, and the insulation product 12 is made to the desired dimensions, such as to the desired thickness. On exiting the oven, the continuous strip of insulation product 12 passes below a drying device 19 that generates hot air (in the direction indicated by the arrow) and above a suction device 13, the role of which is to evacuate the gases contained in the product and to accelerate the cooling of the product. The drying device 19 may be chosen from the devices known to a person skilled in the art, for example composed of at least one gas burner and/or at least one generator of microwaves or of infrared radiation.

The strip of product is then cut up into approximately parallelepipedal panels which are packaged in the form of rolls or folded or non-folded strips, then packed (cutting and packing means not represented).

In accordance with the invention, this conventional production line has added to it a step of treatment with a composition of an agent capable of reacting with formaldehyde in aqueous phase onto the upper face 14 of the insulation product 12, and where appropriate onto the opposite face (lower face), just after the outlet from the oven 9.

This treatment is carried out using a spray boom 15 supplied with the composition of the agent capable of reacting with formaldehyde, comprising a pipe 16 along which nozzles 17 are uniformly distributed (the boom is represented as an enlarged front view at the bottom of FIG. 1 for greater clarity). The nozzles generate jets 18 that are divergent and preferably flat, and that interpenetrate shortly before coming into contact with the upper face 14 of the insulation product 12. The operating conditions of the nozzles, especially the amount of liquid sprayed and the spraying pressure, are adjusted so that the product is impregnated by the composition of the agent capable of reacting with formaldehyde to a thickness that ranges from a few millimeters to a few centimeters. The spray boom 15 is positioned above the product 12 in a substantially horizontal plane, at a distance which may range up to 200 cm, preferably around 20 to 80 cm, from the face 14 and transversely to the axis of travel of the product 12, using a gantry (not represented). The spray boom is also positioned near the outlet from the oven, at a distance which does not exceed 500 cm, preferably 200 cm, and advantageously between 30 and 100 cm, preferably above the suction device 13 in order to allow the penetration of the agent capable of reacting with formaldehyde into the thickness of the insulation product.

The following examples make it possible to illustrate the invention without however limiting it.

In the examples, the following tests are carried out:
thickness recovery: the insulation product is compressed with a compression ratio (defined as being the ratio of the nominal thickness to the thickness under compression) equal to 8/1 for 1, 12, 30 and 90 days. After the compressive stress is removed, the thickness of the insulation product is measured on the product and the thickness recovery, defined by the ratio of the thickness of the product that has been compressed (at the aforementioned compression ratio) to the nominal thickness, is calculated. The measurement of the thickness recovery, expressed in %, allows the dimensional behavior of the product to be assessed.
tensile strength: this is measured according to the standard ASTM C 686-71T on a specimen cut from the insulating product by stamping. The specimen has the shape of a torus 122 mm in length, 46 mm in width, a radius of curvature of the cut at the outer edge equal to 38 mm and a radius of curvature of the cut at the inner edge equal to 12.5 mm.

The specimen is placed between two cylindrical mandrels of a test machine, one of which is mobile and moves at a constant speed. The breaking force F (in gram-force) of the specimen is measured and the tensile strength TS defined by the ratio of the breaking force F to the mass of the specimen is calculated.

The tensile strength is measured after manufacture (initial tensile strength) and after an accelerated ageing in an autoclave at a temperature of 105° C. under 100% relative humidity for 15 minutes (TS15).
emissions of formaldehyde coming from the insulation product: these are measured under the conditions of standards ISO 16000 and EN 13419. The measurement of the formaldehyde emitted is carried out after one day of testing at a temperature of 23° C. and under a relative humidity of 50%. The amount of formaldehyde is measured by high-performance liquid chromatography (HPLC) and post-column reaction under the conditions of the standard ASTM D 5910-96 modified in that the mobile phase is water buffered at pH 6.8, that the oven temperature is equal to 90° C. and that the detection is carried out at 420 nm.

### EXAMPLE 1

A glass wool insulation product having a surface density of around 850 g/m² is manufactured in the production line described in FIG. 1.

The sizing composition contains, in parts by weight:

| | |
|---|---|
| phenol-formaldehyde resol | 60 |
| (example 2, test 1 from WO 01/96254 A1) | |
| urea | 40 |
| ammonium sulfate | 3 |
| silane (Silquest ® A 1100 sold by OSI) | 1 |
| mineral oil | 9.5 |
| aqueous ammonia | 1.2 |

The sizing composition is deposited on the fibers in an amount of 4.7% by weight of dry matter relative to the final insulation product. The sized fibers are then treated in an oven at 260° C.

The composition of the agent capable of reacting with formaldehyde is a 12 wt % aqueous solution of acetoacetamide (example 1a) or of dimethyl acetonedicarboxylate (example 1b). This composition is sprayed onto the upper face of the insulation product, after the oven, in an amount of 20 g/m² (i.e. 2.4 g of dry matter per m² of insulation product). The drying device 19 is a gas burner which generates hot (110-150° C.) air on the upper face 14 of the insulation product.

The insulation product that is treated with the agent capable of reacting with formaldehyde (examples 1a and 1b) and that is not treated (Reference 1) is subjected to the test for formaldehyde emissions. The measurements are given in table 1.

### EXAMPLE 2

The conditions from example 1 are followed, modified in that the sizing composition contains a resol having a low content of free formaldehyde.

The sizing composition contains, in parts by weight:

| | |
|---|---|
| phenol-formaldehyde-monoethanolamine resol | 80 |
| (example 1 from WO-A-2008/043960) | |
| urea | 20 |
| ammonium sulfate | 3 |
| silane (Silquest ® A 1100 sold by OSI) | 1 |
| mineral oil | 9.5 |

The composition of the agent capable of reacting with formaldehyde is a 12 wt % aqueous solution of acetoacetamide (examples 2a and 2b) or of dimethyl acetonedicarboxylate (examples 2c and 2d). These compositions are sprayed onto the upper face of the insulation product, after the oven, in an amount of 20 g/m² (i.e. 2.4 g of dry matter per m² of insulation product) and 10 g/m² (i.e. 1.2 g of dry matter per m² of insulation product), respectively.

The insulation product that is treated with the agent capable of reacting with formaldehyde (examples 2a to 2d) and that is not treated (Reference 2) is subjected to the test for formaldehyde emissions. The measurements are given in table 1.

TABLE 1

| | Agent capable of | | Formaldehyde | | | | | Tensile strength (gF/g) | | |
|---|---|---|---|---|---|---|---|---|---|---|
| | reacting with | Quantity | emitted | Thickness recovery (%) | | | | | After | Loss |
| | formaldehyde | (g/m²) | (μg/m³) | 1 day | 12 days | 30 days | 90 days | initial | ageing | (%) |
| Ex. 1a | Acetoacetamide | 20 | <5 | n.d. | n.d. | n.d. | n.d. | n.d. | n.d. | n.d. |
| Ex. 1b | Dimethyl | 20 | 8 | 141.9 | 138.7 | 136.0 | 134.0 | 273.03 | 211.51 | 22.53 |
| | acetone- | | | | | | | | | |
| | dicarboxylate | | | | | | | | | |
| Ref. 1 | — | — | 45 | 141.3 | 141.3 | 138.8 | 134.7 | 265.38 | 203.64 | 23.26 |
| Ex. 2a | Acetoacetamide | 20 | <5 | n.d. | n.d. | n.d. | n.d. | n.d. | n.d. | n.d. |
| Ex. 2b | Acetoacetamide | 10 | <5 | n.d. | n.d. | n.d. | n.d. | n.d. | n.d. | n.d. |
| Ex. 2c | Dimethyl | 20 | <5 | 139.5 | n.d. | 132.7 | 129.4 | 227.13 | 201.69 | 11.20 |
| | acetone- | | | | | | | | | |
| | dicarboxylate | | | | | | | | | |
| Ex. 2d | Dimethyl | 10 | <5 | 137.4 | n.d. | 127.9 | 127.8 | 211.37 | 201.07 | 4.80 |
| | acetone- | | | | | | | | | |
| | dicarboxylate | | | | | | | | | |
| Ref. 2 | — | — | 12.5 | 135.4 | n.d. | 124.8 | 128.7 | 234.99 | 190.57 | 18.90 |

n.d.: not determined

1. A process of manufacturing a thermal and/or acoustic insulation product comprising mineral wool sized with a thermosetting resin, comprising applying a composition of an agent capable of reacting with formaldehyde, chosen from compounds having active methylene(s), to the insulating product, after the thermosetting resin has crosslinked.

2. The process as claimed in claim 1, wherein the composition of the agent capable of reacting with formaldehyde is applied continuously to the insulating product.

3. The process as claimed in claim 1, wherein the composition comprises the agent capable of reacting with formaldehyde is applied just at the outlet of the heat-treatment device of the oven type whilst the insulation product is still hot; especially at a temperature of around 50 to 80° C., preferably 60 to 70° C.

4. The process as claimed in claim 1, wherein the composition of the agent capable of reacting with formaldehyde is applied to the upper face of the insulation product, and where appropriate to the lower face.

5. The process as claimed in claim 1, wherein the composition of the agent capable of reacting with formaldehyde is applied by spraying or by curtain coating or roll coating.

6. The process as claimed in claim 4, wherein the composition of the agent capable of reacting with formaldehyde is applied by spraying onto the upper face of the insulation product and by roll coating onto the lower face.

7. The process as claimed in claim 1, wherein the compounds having active methylene(s) correspond to the following formulae (I) to (IV): 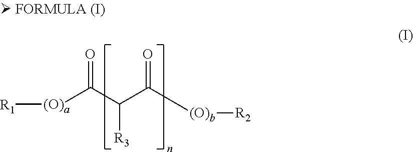
in which:
R₁ and R₂, which are identical or different, represent a hydrogen atom, a C₁-C₂₀, preferably C₁-C₆, alkyl radical, an amino radical or a radical of formula 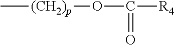
in which R₄ represents a 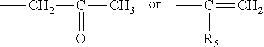
radical, where R₅=H or —CH₃
and p is an integer that varies from 1 to 6;
R₃ represents a hydrogen atom, a C₁-C₁₀ alkyl radical, a phenyl radical or a halogen atom;
a is equal to 0 or 1;
b is equal to 0 or 1; and
n is equal to 1 or 2,
FORMULA (II)
R₆—CHR₇—C≡N (II)
in which:
R₆ represents a cyano radical or a 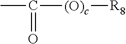
radical
in which:
R₈ represents a hydrogen atom, a C₁-C₂₀, preferably C₁-C₆, alkyl radical, or an amino radical;
c is equal to 0 or 1; and
R₇ represents a hydrogen atom, a C₁-C₁₀ alkyl radical, a phenyl radical or a halogen atom. 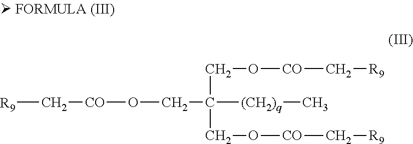
in which:
R₉ represents a —C≡N or —CO—CH₃ radical; and
q is an integer that varies from 1 to 4, 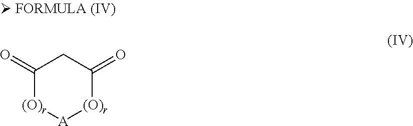
in which:
A represents a —(CH₂)₃— or —C(CH₃)₂— radical; and
r is equal to 0 or 1.

8. The process as claimed in claim 7, wherein the compound of formula (I) is selected from the group consisting of 2,4-pentanedione, 2,4-hexanedione, 3,5-heptanedione, 2,4-octanedione, acetoacetamide, N-monomethyl-acetoacetamide, N-monoethylacetoacetamide, N,N-dimethylacetoacetamide, N,N-diethylacetoacetamide, acetoacetic acid, methyl acetoacetate, ethyl acetoacetate, n-propyl acetoacetate, isopropyl acetoacetate, isobutyl acetoacetate, t-butyl acetoacetate, n-hexyl acetoacetate, malonamide, malonic acid, dimethyl malonate, diethyl malonate, di-n-propyl malonate, diisopropyl malonate, di-n-butyl malonate, acetonedicarboxylic acid and dimethyl acetonedicarboxylate.

9. The process as claimed in claim 7, wherein the compound of formula (II) is selected from the group consisting of 2-methyl cyanoacetate, 2-ethyl cyanoacetate, 2-n-propyl cyanoacetate, 2-isopropyl cyanoacetate, 2-n-butyl cyanoacetate, 2-isobutyl cyanoacetate, 2-tert-butyl cyanoacetate, 2-cyanoacetamide and propanedinitrile.

10. The process as claimed in claim 7, wherein the compound of formula (III) is trimethylolpropane triacetoacetate and trimethylolpropane tricyanoacetate.

11. The process as claimed in claim 7, wherein the compound of formula (IV) is 1,3-cyclohexanedione and Meldrum's acid.

12. The process as claimed in claim 1, wherein the thermosetting resin is a resol of the phenol-formaldehyde or phenol-formaldehyde-amine type.

13. The process as claimed in claim 1, wherein the composition of the agent capable of reacting with formaldehyde is a solution, a dispersion or an emulsion in a liquid phase comprising more than 50% by weight of water and of one or more organic cosolvents of said agent.

14. The process as claimed in claim 13, wherein the liquid phase contains 75 to 90% water.

15. The process as claimed in claim 1, wherein the agent capable of reacting with formaldehyde is liquid and it is applied as is to the insulation product, without addition of water and of cosolvents.

16. A device for carrying out the process as claimed in claim 1, comprising a line for producing mineral wool, comprising a plurality of fiberizing members in series, at least one member for receiving/conveying the fibers resulting from the fiberizing members, one or more members for applying a sizing composition and one or more heat-treatment members of the oven type, wherein the line also comprises at least one spray boom for spraying a composition of an agent capable of reacting with formaldehyde onto the upper face of the insulation product downstream of the heat-treatment member(s).

17. The device as claimed in claim 16, wherein the spray boom comprises a feed pipe provided with spray nozzles uniformly distributed over the length of the boom(s) and capable of producing jets of liquid that are divergent and preferably “flat”.

18. The device as claimed in claim 16, wherein the spray boom is placed above the upper face of the insulation product.

19. The device as claimed in claim 18, wherein the first boom is facing a device that ensures the drying of said product, located below the lower face of said product.

20. The device as claimed in claim 16, further comprising one or more coating rolls that allow the application of the composition of the agent capable of reacting with formaldehyde to the lower face of the insulation product.

21. The device as claimed in claim 20, wherein the roll is positioned downstream of the heat-treatment member and of the device ensuring the drying of said product.

22. A thermal and/or acoustic insulation product obtained by the process as claimed in claim 1, which comprises, at the surface, an agent capable of reacting with formaldehyde chosen from compounds having active methylene.

23. The product as claimed in claim 22, wherein the amount, by dry weight, of agent capable of reacting with formaldehyde varies from 0.01 to 50 g/m² of final insulation product.
